(19) United States
(12) Patent Application Publication
(10) Pub. No.: US 2018/0015403 A1
(43) Pub. Date: Jan. 18, 2018

(54) DE-ICING OF PULSE FILTERS

(71) Applicant: General Electric Company, Schenectady, NY (US)

(72) Inventors: Bradly Aaron Kippel, Greenville, SC (US); Giorgio Marchetti, Ancona (IT)

(21) Appl. No.: 15/211,187

(22) Filed: Jul. 15, 2016

(51) Int. Cl. B01D 46/00; B01D 46/02; F01D 25/00; B01D 46/54; F02C 7/04

(52) U.S. Cl. CPC B01D 46/0068; B01D 46/543; F02C 7/04; F01D 25/002; B01D 46/02; B01D 2275/10; F05D 2220/32; B01D 2279/60

(57) ABSTRACT

Aspects of the disclosure include methods and systems for the de-icing of pulse filters, such as those used in turbomachinery. A method according to the present disclosure can include: coupling a filter bag to the pulse filter such that the filter bag is in a contracted position, the filter bag having a complementary geometry relative to the pulse filter, such that the filter bag occupies an airflow cross-section of the pulse filter, and wherein the filter bag is composed of one of a hydrophilic material, a hydrophobic material, or an oleophobic material; and pulsing a compressed air through the pulse filter and the filter bag during operation of the gas turbine, such that the filter bag expands to dislodge ice from an outer surface of the filter bag.

### BACKGROUND

The disclosure relates generally to treating one or more pulse filters configured for use with, e.g., a turbine component in a turbomachine such as a gas turbine. More specifically, embodiments of the present disclosure can include a filter bag coupled to a pulse filter, and methods of using a filter bag to remove ice from the pulse filter.

Turbomachinery, and other machine assemblies which include turbine components therein, may be deployed in a large number of environments to serve different groups of customers. In extreme conditions, such as environments with an average ambient temperature of less than zero degrees Celsius, the pressure drop of operative fluids passing through an inlet to the turbine component may increase and affect a power output produced by the turbine or machine assembly. In some cases, the formation of ice on one or more components of the inlet to the turbine component can cause such operational differences to become more pronounced. Conventional methodologies for removing ice from an inlet to a turbine component may require removal and/or replacement of sub-components within the inlet.

### SUMMARY

A first aspect of the disclosure provides a method of de-icing a pulse filter positioned within an inlet to a turbine component of a gas turbine, wherein the method comprises: coupling a filter bag to the pulse filter such that the filter bag is in a contracted position, the filter bag having a complementary geometry relative to the pulse filter, such that the filter bag occupies an airflow cross-section of the pulse filter, and wherein the filter bag is composed of one of a hydrophilic material, a hydrophobic material, or an oleophobic material; and pulsing a compressed air through the pulse filter and the filter bag during operation of the gas turbine, such that the filter bag expands to dislodge ice from an outer surface of the filter bag.

A second aspect of the disclosure provides a turbine filtration system including: a pulse filter for an inlet to a turbine component of a gas turbine, and a hydrophilic filter bag coupled to the pulse filter and having a complementary geometry relative to the pulse filter, such that the hydrophilic filter bag occupies an airflow cross-section of the pulse filter, wherein the pulse filter and the hydrophilic filter bag are each in fluid communication with a reservoir of compressed air within the gas turbine.

A third aspect of the invention provides a system including: a pulse filter for an inlet to a turbine component of a gas turbine, and a hydrophilic filter bag coupled to the pulse filter and having a complementary geometry relative to the pulse filter, such that the hydrophilic filter bag occupies an airflow cross-section of the pulse filter, wherein the pulse filter and the hydrophilic filter bag are each in fluid communication with a reservoir of compressed air within the gas turbine.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 provides a schematic depiction of a conventional turbomachine.

FIG. 2 provides a schematic depiction of a turbine component inlet and pulse filters according to embodiments of the present disclosure.

FIG. 3 provides a perspective view of a pulse filter with a hydrophilic filter bag thereon according to embodiments of the present disclosure.

FIG. 4 provides a perspective view of a system with a pulse filter and contracted hydrophilic filter bag according to embodiments of the present disclosure.

FIG. 5 provides a perspective view of a system with a pulse filter and expanded hydrophilic filter bag according to embodiments of the present disclosure.

FIG. 6 provides a perspective view an expanded hydrophilic filter bag with an undulating surface area according to embodiments of the present disclosure.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be used and that changes may be made without departing from the scope of the present teachings. The following description is, therefore, merely exemplary.

Where an element or layer is referred to as being “on,” “engaged to,” “disengaged from,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

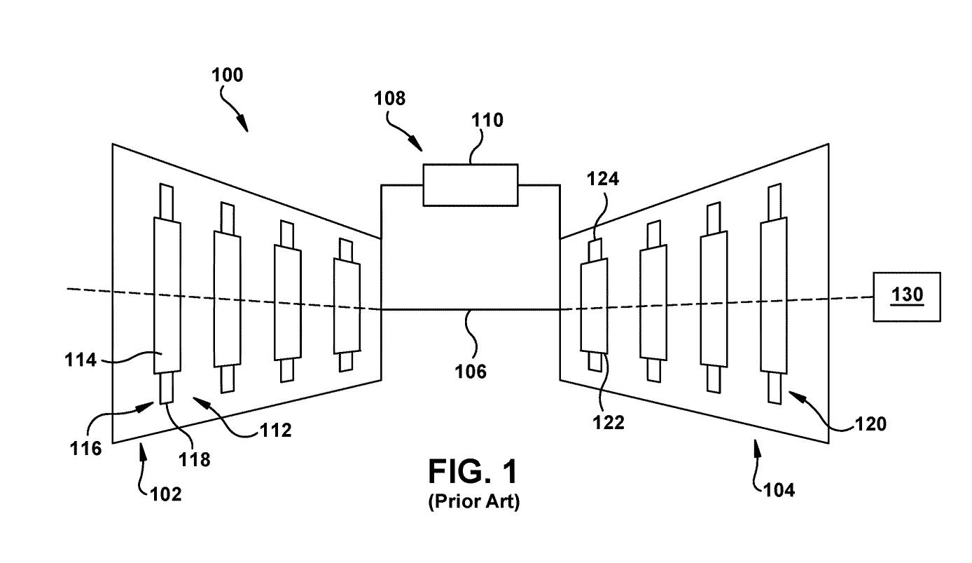

FIG. 1 shows a conventional turbomachine 100 that includes a compressor 102 operatively coupled to a turbine component (“turbine”) 104 through a shared compressor/turbine shaft 106. Turbomachine 100 is depicted as being in the form of a gas turbine in FIG. 1, but it is understood that other types of machines (e.g., steam turbines, water turbines, etc.) can be substituted for gas turbines in embodiments of the present disclosure. More generally, any machine which includes an embodiment of compressor 102 can be used, modified, and/or controlled as discussed herein. Compressor 102 can be fluidically connected to turbine 104, e.g., through a combustor assembly 108. Combustor assembly 108 includes one or more combustors 110. Combustors 110 may be mounted to turbomachine 100 in a wide range of configurations including, but not limited to, being arranged in a can-annular array. Compressor 102 includes a plurality of compressor rotor wheels 112. Compressor rotor wheels 112 include a first stage compressor rotor wheel 114 having a plurality of first stage compressor rotor blades 116 each having an associated airfoil portion 118. Similarly, turbine 104 includes a plurality of turbine wheel components 120 including one or more rotor wheels 122 having a set of corresponding turbine rotor blades 124.

During operation, an operative fluid such as a combusted hot gas can flow from combustor(s) 110 into turbine 104. The operative fluid in turbine 104 can pass over multiple rotor blades 124 mounted on turbine wheel 122 and arranged in a group of successive stages. The first set of turbine blades 124 coupled to wheel 122 and shaft 106 can be identified as a “first stage” of turbomachine 100, with the next set of turbine blades 124 being identified as a “second stage” of turbomachine 100, etc., up to the last set of turbine blades 124 in a final stage of turbomachine 100. The final stage of turbomachine 100 can include the largest size and/or highest radius turbine blades 124 in turbomachine 100. A plurality of respective nozzles (not shown) can be positioned between each stage of turbomachine 100 to define inter-stage portions of a flow path through turbomachine 100. The operative fluid flowing over each turbine blade 124 can rotate blades 124 by imparting thermal and mechanical energy thereto, and causing shaft 106 of turbomachine 100 to rotate. Shaft 106 can generate power by being mechanically coupled to a generator component 130 which converts mechanical energy of shaft 106 into electrical energy for powering devices connected to generator 130. The amount of electrical energy produced by generator 130 can be measured, e.g., in Joules (J) as an amount of work and/or power produced by turbomachine 100.

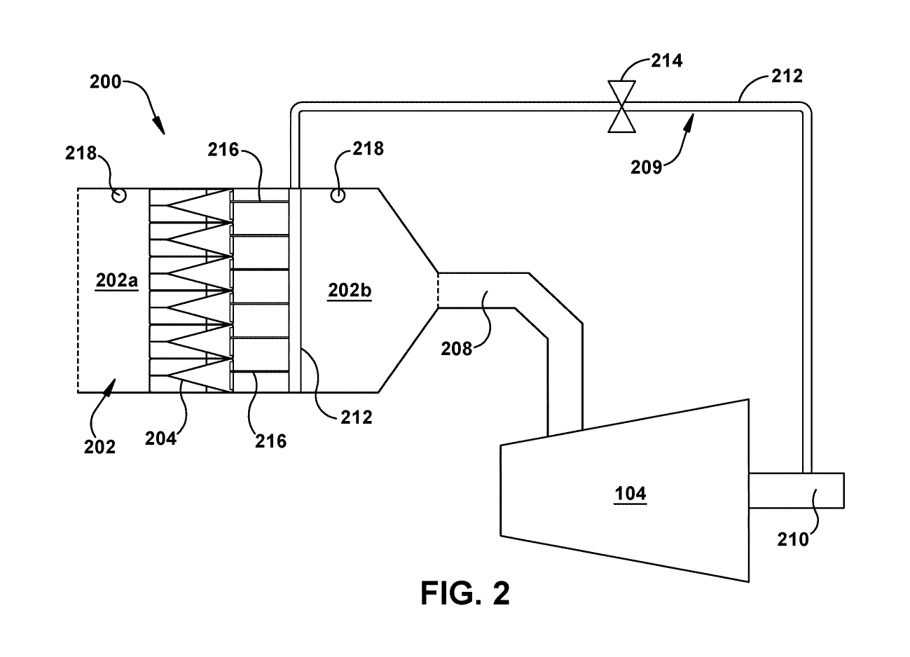

Turning to FIG. 2, a system 200 according to the present disclosure can include and/or be in fluid communication with an inlet 202 (divided into a fore inlet 202a and an aft inlet 202b) to turbine 104 of turbomachine 100 (FIG. 1) to provide de-icing of pulse filters 204 used with turbine 104, as described herein. Operative fluids routed to turbine 104 can travel through fore inlet 202a, before passing through pulse filters 204 which separate fore inlet 202a from aft inlet 202b. Each pulse filter 204 can be made up of multiple subcomponents as described elsewhere herein. Aft inlet 202b can be in fluid communication with a transition section 208 for routing operative fluids (e.g., uncombusted air obtained from ambient) to turbine 104.

These present disclosure can include and/or use embodiments of a filter treatment assembly 209 included within and/or coupled to inlet 202. Filter treatment assembly 209 can include, e.g., a compressed air source 210 positioned at an outlet of turbine 104 can contain compressed generated by components of a machine, e.g., compressor 102 (FIG. 1) of turbomachine 100. Compressed air source 210 can include, e.g., a path of compressed operating fluid independent from the flow through turbine 104, and/or can be embodied as an independent source of compressed air yielded from compressor(s) 102 or other devices. A conduit 212 of filter treatment assembly 209 can provide fluid communication between compressed air source 210 and other components, and a control valve 214 can govern the flow of compressed air from compressed air source 210 through conduit 212. One or more pulsing lines 216 can be positioned within aft inlet 202b and substantially aligned with an outlet from pulse filter(s) 204, such that an operator can selectively direct compressed air from compressed air source 210 to flow to pulse filter(s) 204. During operation, filter treatment assembly 209 can selectively pulse compressed air into pulse filter(s) 204 through conduit 212 to remove ice from subcomponents of pulse filter(s) 204, discussed herein.

One or more pulse filters 204 may be positioned in a flow path for filtering operative fluid entering turbine 104. Each pulse filter 204 can structurally separate fore inlet 202a from aft inlet 202b to turbine 104. The number and size of pulse filters 204 may be selected such that substantially all of the operative fluid within inlet 202 passes through pulse filter(s) 204 to remove some contaminants (e.g., dust, exhaust, gaseous fuels, etc.) before it enters turbine 104. Turbine 104 may be sensitive to the pressure and other properties of operative fluid transmitted thereto from transition section 208, particularly for turbomachines 100 (FIG. 1) operating in a sub-zero environment (i.e., an environment with an ambient temperature less than approximately zero degrees Celsius).

As a result of turbomachine 100 (FIG. 1) being positioned in a sub-zero environment, an outlet from turbine 104 can also have an average ambient temperature of less than zero degrees Celsius during operation. Residual amounts of ice may form on pulse filters 204 in turbomachines 100 deployed in a sub-zero environment. In particular, the design geometry of pulse filters 204 may provide surfaces where ice can form during operation in a sub-zero environment. Among other things, embodiments of the present disclosure provide a system and method for removing ice from pulse filters 204 (i.e., for “de-icing”) of turbomachine 100. The de-icing of turbomachine 100 can occur during operation of turbomachine 100, while turbomachine 100 is offline, and/or during transitional operating states of turbomachine 100. As discussed elsewhere herein, operative fluids passing through fore and aft inlets 202a, 202b may exhibit a significant pressure drop across pulse filter(s) 204 as a result of ice formation. Fore and aft inlets 202a, 202b can include one or more pressure sensors 218 (e.g., barometers, manometers, pressure transducers, etc.) to measure the pressure of operative fluids before and after passing through pulse filters 204.

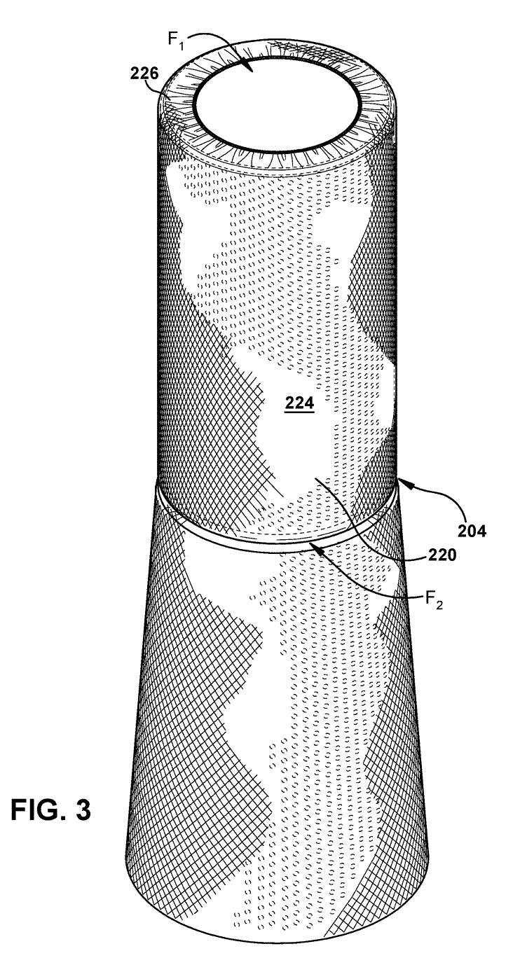

To illustrate features and subcomponents of pulse filter(s) 204 in embodiments of system 200 (FIG. 2), a perspective view of one pulse filter 204 is shown in FIG. 3. Pulse filter(s) 204 can be manufactured to include partially or substantially cylindrical geometries, which may include similarly or differently shaped sub-components therein. In some cases, pulse filter(s) 204 may alternatively include substantially rectangular, triangular, and/or complex polygonal external geometries to accommodate varying turbomachines 100 (FIG. 1) and/or operational settings. Pulse filter(s) 204 are shown and described herein as including a complimentary cylindrical and conical geometry solely for the purposes of example and demonstration. However, other pulse filter(s) 204 can include, e.g., multiple bodies each having cylindrical, conical, rectangular, toroidal, frusto-conical, and/or other complex three-dimensional shapes.

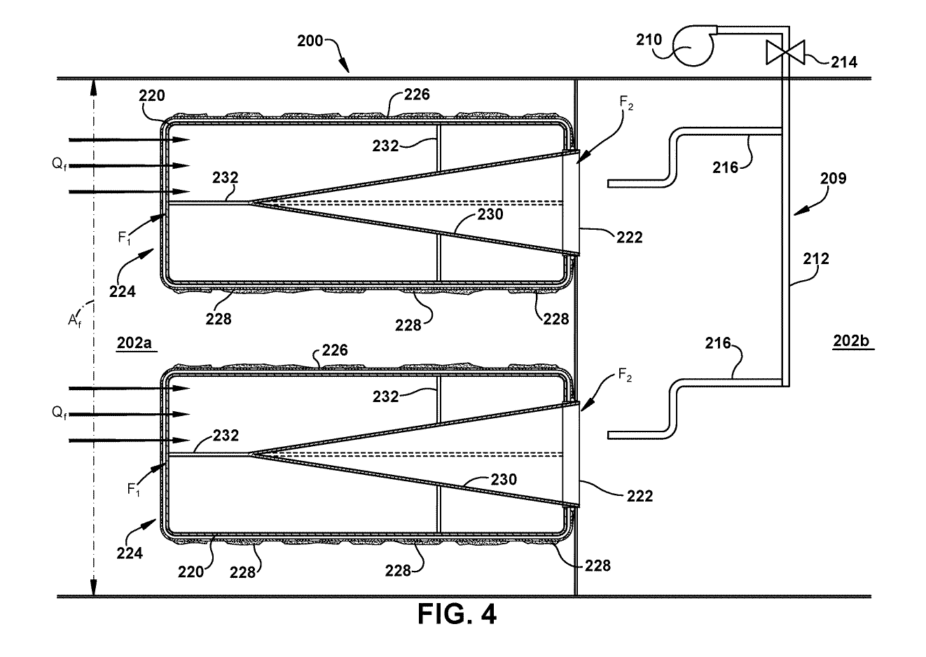

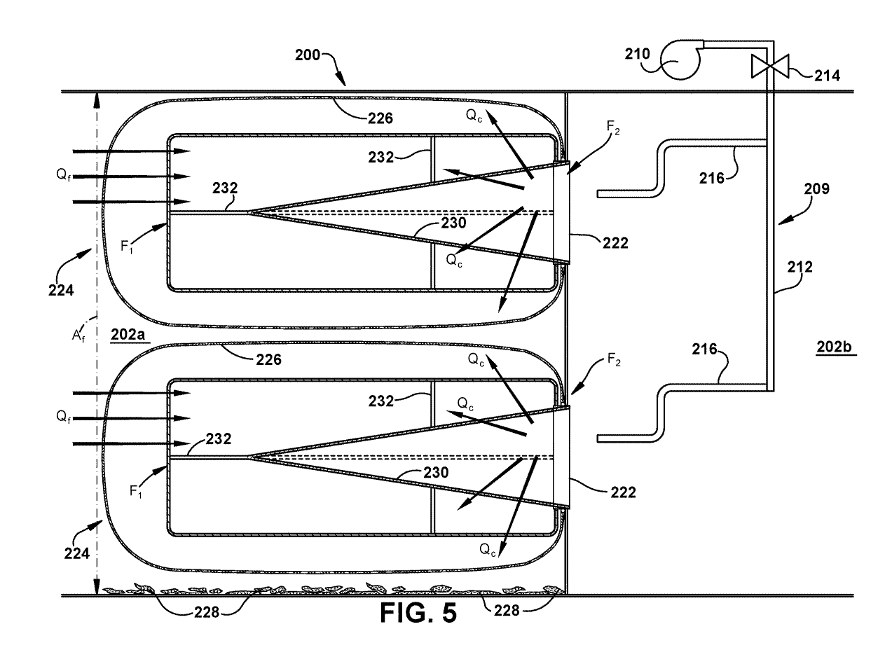

In an example embodiment, each pulse filter 204 can include a body 220 extending from a first end F₁ to a second end F₂. Body 220 can be composed of a rigid material constructed into a mesh, such that the mesh structure of body 220 catches and removes contaminants from operative fluids passing through pulse filter(s) 204. More specifically, body 220 can be include a fibrous, porous filter material which includes one or more pleated and/or non-pleated materials such as glass, synthetic fibers, cellulose, and/or other filtering materials. In other embodiments, body 220 can be composed of a mesh of metals, plastics, and/or other conventional rigid structural materials formed in a mesh with a high porosity, with a layer of filter materials provided thereon as an external sheet, membrane, surface treatment, etc. A flow of operative fluid through pulse filter(s) 204 from first end F₁ to second end F₂ can pass through body 220, while body 220 selectively removes contaminants from the operative fluid. The porosity and shape of the material composition of body 220 and surface treatments thereon can vary based on the intended application of pulse filter(s) 204, the operative fluids transmitted therethrough, etc. It is also understood that the exterior shape of body 220 can vary based on the shape of inlet 202 (FIG. 2). For example, as shown in FIGS. 4-5 and discussed elsewhere herein, first end F₁ of body 220 may have a narrower cross-section than second end F₂. Differences in cross-sectional area between first and second ends F₁, F₂ may cause the exterior surface of body 220 to be tapered, e.g., in a uniform manner or by including a stepped exterior profile. Body 220 may generally resemble a cylindrical shape (including, e.g., partially conical exterior profiles) regardless of any differences in cross-sectional area between the two ends F₁, F₂ of body 220, e.g., by virtue of having less than approximately a ten percent reduction in cross-sectional area between first and second ends F₁, F₂ of body 220. Body 220 can be shaped, e.g., such that first end F₁ exhibits at least approximately ninety percent of the total cross-sectional area exhibited by second end F₂. It is also understood that the exterior housing of pulse filter 204 can alternatively include other types of geometries, tapered sidewalls, etc.

As discussed elsewhere herein, compressed air from filter treatment assembly 209 can pass through pulsing line 216, which may be substantially aligned with channel(s) 222 such that air may be directed through pulse filter(s) 204 in a direction opposing the flow of operative fluid through pulse filter(s) 204. Channels 222 of each pulse filter 204 may be laterally separated from each other by rigid structural members, e.g., a solid surface positioned extending through a cross-section of inlet 202 between each pulse filter 204. Body 220 of pulse filter 204 can be shaped to define a desired cross-sectional area of each corresponding channel 222.

A filter bag 224 can enclose body 220 of pulse filter 204. When uninflated, filter bag 224 can be substantially cylindrical and/or shaped to enclose body 220 of pulse filter 204. Filter bag 224 can be open on one end, such that filter bag 224 is not positioned within channel 222. Where body 220 and/or portions thereof are shaped to include a tapered geometrical profile as a result of differences in cross-sectional area between its first and second ends F₁, F₂, filter bag 224 may also have a tapered geometry with varying cross-sectional areas at its opposing ends. Alternatively, filter bag 224 can have a geometry which complements (i.e., approximately mimics) the surface profile of pulse filter 204 regardless of whether body 220 includes a tapered shape. Filter bag 224 can be fluidically sealed to a circumferential end of body 220, such that operative fluid within inlet 202 (FIG. 2) also passes through filter bag 224 when passing through pulse filter(s) 204. The interior of filter bag 224 can be in fluid communication with filter treatment assembly 209, e.g., by being substantially linearly aligned with an outlet from pulsing line 216 to receive a flow of compressed air expelled therefrom. Where multiple pulse filters 204 are used in system 200, each can have a respective channel 222 in fluid communication with a corresponding pulsing line 216 and/or a portion of a unitary pulsing line 216.

Filter bag 224 can be composed of a different material from any materials within and/or on body 220. Filter bag 224 can be composed of one or more expandable fabrics which exhibit intrinsic hydrophilic, hydrophobic, and/or oleophobic properties. In addition or alternatively, filter bag 224 can be coated with a surface treatment 226 with hydrophilic, hydrophobic, and/or oleophobic properties. The composition of filter bag 224 and/or surface treatment 226 can thus include one or more currently known or later developed hydrophobic materials, hydrophilic materials, and/or oleophobic materials. Surface treatment 226 may be provided, e.g., in the form of a chemical treatment (e.g., a coating applied to the exterior surface of filter bag 224), a membrane positioned on and conformally coating filter bag 224, etc. Surface treatment 226 can be formed on filter bag 224 by one or more currently-known or later developed techniques for applying a surface treatment to an expandable fabric, e.g., lamination, spray coating, and/or deposition. Such membranes and chemical treatments are referred to collectively herein by reference to surface treatment(s) 226.

In the case of filter bags 224 or surface treatments 226 with hydrophobic properties, the expandable fabric composition of filter bag 224 can include, e.g., an expandable fabric such as polypropylene, polytetrafluoroethylene (PTFE), polyester, and/or other similar fabrics with an expandable composition. Alternatively, filter bag 224 and/or surface treatment(s) 226 can include hydrophilic materials can include, e.g. Polycarbonate Trach Etch (PCTE), Polyethersulfone (PES), PTFE, and/or other similar fabrics. In still further embodiments, the composition of filter bag 224 or surface treatment(s) 226 can include one or more oleophobic (i.e., oil fearing) materials and/or fabrics, e.g., PTFE and/or other oil-resistant, polymer-based fabrics. Filter bags 224 and/or surface treatment(s) 226 composed of hydrophilic materials can be configured to entrap water and/or ice (collectively “ice”) 228 therein, such that ice 228 can be removed from filter bag 224 in other process steps. Filter bags 224 and/or surface treatments 226 composed of hydrophobic and/or oleophobic materials and cause ice 228 to bead (e.g., form as a spherical deposit) on the surface of filter bag 224 during operation of turbomachine 100. Regardless of the composition of filter bag 224 or surface treatment(s) 226, methods according to the present disclosure can allow ice 228 to form on surface treatment(s) 226 and/or filter bag(s) 224 such that filter treatment assembly 209 can remove ice 228 directly from filter bag(s) 224 in other processes described herein.

Regardless of the selected composition, filter bag 224 can be configured to inflate in response to one or more perturbations (e.g., pressure imparted by a flow of air, fluid, etc.) to its structural composition, as compared to non-expanding materials or fabrics. The composition of surface treatment 226 can be different from the composition of filter bag 224 and/or can include modified versions of the same materials, e.g., hydrophilic, hydrophobic, and/or oleophobic polyester, polyurethane, and/or other polymer or polymer-based materials. During operation, filter bag 224 and/or its surface treatment 226 can capture ice 228 and/or intermixed contaminants (collectively “ice”) thereon to prevent the same from forming on portions of pulse filter(s) 204, e.g., on body 220. Filter bag 224 thereby provides a component where ice 228 can eventually form without affecting the condition or operation of each pulse filter 204, and as discussed elsewhere herein, ice can be dislodged from filter bag 224 as it expands in response to being filled and inflated by compressed air delivered from filter treatment assembly 209.

Turning to FIG. 4, a partial perspective view of system 200 is shown to further emphasize structural features of each pulse filter 204, and processes of removing ice 228 according to embodiments of the present disclosure. As discussed elsewhere herein, body 220 of pulse filter 204 can include a fibrous, porous material for removing some contaminants from a flow of operative fluid Qf passing through inlet 202. One or more pulse filters 204 can be positioned within inlet 202 such that a majority or substantially all operative fluid within an airflow cross-section A_{f} passes through pulse filter(s) 204 and corresponding channel(s) 222. Thus, it is understood that an array of pulse filter(s) 204 and their respective filter bags 224 can occupy substantially an entire airflow cross section A_{f} within inlet 202, due to the presence of static surfaces positioned laterally between pulse filter(s) 204 and connected to second end(s) F₂ thereof. Pulse filter(s) 204 of system 200 may be arranged in a side-by-side horizontal formation such that first and second ends F₁, F₂ of each pulse filter 204 are substantially aligned, but it is understood that other arrangements and/or orientations of pulse filters 204 are contemplated.

In an example embodiment, each pulse filter 204 can include one or more support members 230 positioned within body 220 and mechanically coupled to inlet 202, e.g., at a reference surface positioned at second end F₂ of pulse filter 204. Support members 230 can optionally include a group of supports 232 (e.g., gaskets, mounts, tabs, fixed structural members, etc.) can radially and/or axially couple body 220 of pulse filter 204 to other elements of system 200 positioned within inlet 202. For example, body 220 can include a substantially circular end concentric with channel 222, with support member(s) 230 being connected to body 220 proximal to first end F₁ and a portion of inlet 202 proximal to second end F₂.

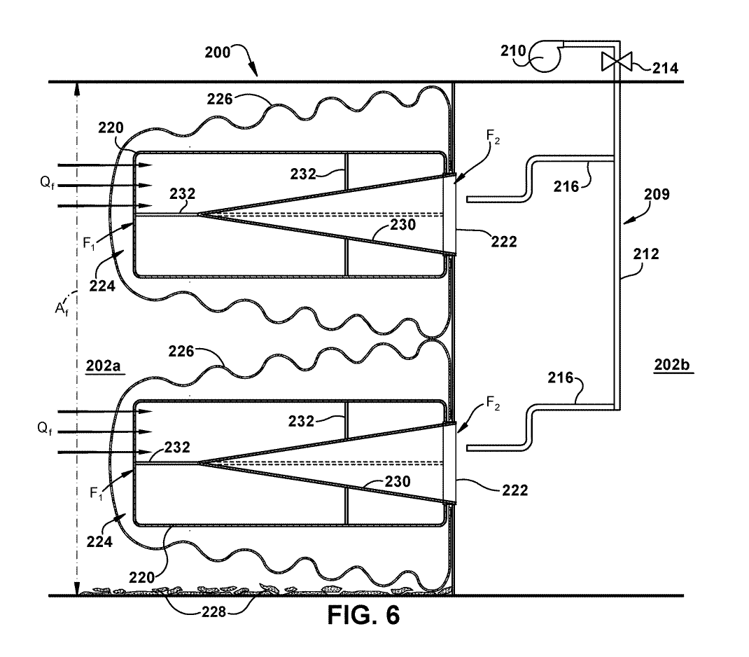

Referring to FIGS. 4 and 5, together, methods of de-icing pulse filter(s) 204 in embodiments of the present disclosure are shown. FIG. 4 depicts filter bag 224 in a contracted position, while FIG. 5 (and FIG. 6, described elsewhere herein) depict embodiments of filter bag 224 in an expanded position. Filter bag 224 in the contracted position depicted in FIG. 4 may not collapse or expand in a reverse direction because it presses against conical and/or cylindrical bodies 220 of pulse filter 204. During operation of turbomachine 100 (FIG. 1), one or more deposits of ice 228 can form on surface treatment 226 and/or filter bag 224, e.g., by becoming embedded in the composition of hydrophilic materials therein or beading on the exterior of hydrophobic and/or oleophobic materials therein. Filter bag 224 can circumferentially enclose pulse filter(s) 204, thereby obstructing or preventing ice 228 from forming on bodies 220 of pulse filter(s) 204. Filter treatment assembly 209 can be coupled to each pulse filter 204 through pulsing line 216, such that compressed air can selectively expand filter bag 224 to dislodge ice 228 from surface treatment 226 and/or filter bag 224. As described elsewhere herein, filter treatment assembly 209 can include compressed air source 210 fluidly connected to conduit 212 and pulsing line 216. As a result, these components can be in fluid communication with pulse filter(s) 204 and filter bag(s) 224 of system 200, e.g., by being in fluid communication with channel(s) 222. Control valve 214 can be coupled to conduit 212 and configured to control the flow of compressed air through conduit 212 to pulsing line 216. Filter treatment assembly 209 may be one of several filter treatment assemblies 209 in a single turbomachine 100 and/or inlets 202a, 202b.

During operation, a user can adjust the position of control valve 214 to pulse a flow of compressed air Q_{c} (FIG. 4 only) from pulsing line 216. A positive pressure differential between compressed air source 210 and inlet 202 can cause compressed air to flow from compressed air source 210 to inlet 202 through conduit 212 when control valve 214 is opened. The positive pressure differential can cause the flow of compressed air Q_{c} from pulsing line 216 to be directed in opposition to a flow of operative fluid Q_{f} through pulse filter(s) 204. The flow of compressed air Q_{c} can expand fabric of filter bag 224, as shown in FIG. 4, thereby physically dislodging ice 228 from the surface of surface treatment 226 of filter bag(s) 224. The dislodged ice 228 can be collected, e.g., in a receptacle (not shown) for receiving the dislodged ice, and/or can be removed from inlets 202a, 202b of turbine 104 (FIGS. 1, 2) in a subsequent process. As filter treatment assembly 209 pulses compressed air through pulse filter 204, filter bag 224 can remain coupled to pulse filter 204, e.g., through support member 222, thereby allowing hydrophilic filter bag 225 to be used in multiple instances of de-icing turbine 104 (FIGS. 1-2).

Methods according to the present disclosure can dislodge ice 228 from pulse filter(s) 204 during operation of a machine in an environment with a sub-zero temperature. To reflect this setting of operation, methods according to the present disclosure can include initiating operation of a machine (e.g., turbomachine 100 (FIG. 1) and/or turbine 104 (FIGS. 1, 2)) in a sub-zero environment. The additional process steps described herein can be implemented as independently from and/or successively to initiating the operation of a machine in a sub-zero environment. Thereafter, a user can mechanically couple filter bag(s) 224 to respective pulse filter(s) 204, e.g., proximal to boundaries of channel(s) 222 and/or to support member(s) 230. As turbine 104 operates in a sub-zero environment, ice 228 may eventually form on filter bag(s) 224 over time. To dislodge ice 228, a user can periodically pulse a compressed air through pulse filter(s) 204 and/or filter bag(s) 224 to remove ice 228 therefrom. Methods according to the present disclosure can be implemented with the aid of filter treatment assemblies 209, described elsewhere herein, which can be controlled by a technician and/or computing device adjusting control valve 214 to permit or prohibit compressed air from flowing from compressed air source 210 through conduit 212 to pulsing line 216. The flow of compressed air exiting pulsing line 216 can cause filter bag(s) 224 to expand, dislodging ice 228 from filter bag(s) 224.

In alternative embodiments, the pulsing of compressed air can be conditioned on other physical properties of system 200. It may be desirable to limit the pulsing of compressed air to situations where a substantial amount of ice 228 forms on filter bag(s) 224, e.g., to conserve compressed air in compressed air source 210 for other purposes. To provide this feature, methods according to the present disclosure can include measuring a pressure drop between inlets 202a, 202b across pulse filter(s) 204 e.g., using pressure sensors 218 (FIG. 2). The measurement of pressure can be performed in real time to actively control the use of system 200. A user and/or computer system can determine whether the measured pressure drop exceeds a predetermined threshold, e.g., set by a user or stored in memory of a computing device. Where the pressure drop across pulse filter(s) 204 is below the threshold, additional measurements of pressure drop are collected. Where the pressure drop exceeds one or more predetermined thresholds, compressed air can be pulsed through pulse filter(s) 204 and/or filter bag(s) 224 to dislodge ice from surface treatment(s) 226. In an example embodiment of the present disclosure, a user and/or system can define the threshold pressure drop across pulse filter(s) 204 as being, e.g., 0.30 kilopascals (kPa). Where pressure sensor(s) 218 measure a pressure drop of, e.g., 0.35 kPa, air can be pulsed through pulse filter(s) 204 to dislodge ice from surface treatment(s) 226. Where pressure sensor(s) 218 measure a pressure drop of, e.g., 0.25 kPa, additional measurements can be collected as a result of this pressure differential indicating insignificant ice formation.

Referring to FIG. 6, embodiments of the present disclosure can include filter bag(s) 224 with alternative shapes configured to increase the surface area, when expanded, to better break off and dislodge any ice 228 formation on filter bag(s) 224. In particular, each filter bag 224 can be shaped such that, when expanded, its exterior surface exhibits an undulating or “fir tree” shape. Such undulating shapes of filter bag(s) 224 can provide a greater surface area than corresponding pulse filter(s) 204, e.g., to increase the amount of ice 228 formed on filter bag(s) 224 and removed therefrom. Although the undulating exterior surface of each filter bag 224 can vary based on intended use and/or operation, it is understood that the exterior surface of each filter bag(s) 224 can be shaped to include, e.g., a surface area that is twice as large, three times larger, five times larger, etc., than the exterior surface of pulse filter(s) 204 (e.g., on body 220). In addition to the undulating exterior surfaces of filter bag(s) 220 shown in FIG. 6, alternative embodiments may provide a variety of other exterior surface geometries for filter bag(s) 224 which do not mimic or geometrically correspond to the exterior surface geometry of corresponding pulse filter(s) 204.

Embodiments of the present disclosure can provide several technical and commercial advantages, some of which are discussed herein for the purposes of example. Embodiments of the methods and systems described herein can improve the performance and lifespan of a turbomachine by preventing a pressure drop across pulse filters 204 from exceeding particular values, e.g., safety limits, when operating in a sub-zero environment. In addition, applying filter bags 224 according to embodiments of the present disclosure can prevent ice 228 from forming on sensitive components of pulse filter(s) 204, and instead cause ice to form only on filter bags 224 from which ice can be dislodged, e.g., using filter treatment assembly 209. Systems and methods according to the present disclosure can provide reusable components (e.g., filter bag 224, surface treatments 226, etc.) which can easily be cleaned and/or replaced without requiring pulse filter(s) 204 to be removed. In addition, embodiments of the present disclosure contemplate surface treatment(s) 226 with varying material compositions (e.g., hydrophilic, hydrophobic, and/or oleophobic materials) such that ice 228 can form on filter bag(s) 224 for removal in several manners (e.g., by being entrapped therein or beading on the exterior of filter bag(s) 224), and in a variety of operational settings.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of de-icing a pulse filter positioned within an inlet to a turbine component of a gas turbine, wherein the method comprises:
coupling a filter bag to the pulse filter such that the filter bag is in a contracted position, the filter bag having a complementary geometry relative to the pulse filter, such that the filter bag occupies an airflow cross-section of the pulse filter, and wherein the filter bag is composed of one of a hydrophilic material, a hydrophobic material, or an oleophobic material; and
pulsing a compressed air through the pulse filter and the filter bag during operation of the gas turbine, such that the filter bag expands to dislodge ice from an outer surface of the filter bag.

2. The method of claim 1, further comprising initiating operation of the gas turbine in an environment having an ambient temperature below zero degrees Celsius, after the coupling of the filter bag to the pulse filter.

3. The method of claim 1, wherein the expanded filter bag includes an undulating surface area during the pulsing of compressed air through the pulse filter and the filter bag.

4. The method of claim 1, wherein the filter bag remains coupled to the pulse filter during the pulsing of compressed air through the pulse filter and the filter bag.

5. The method of claim 1, wherein the filter bag includes an expandable fabric and a hydrophilic surface treatment on an exterior surface of the expandable fabric, the hydrophilic surface treatment including one of a membrane or a chemical treatment formed on an the exterior surface.

6. The method of claim 5, wherein the expandable fabric includes at least one material selected from a group consisting of Polycarbonate Trach Etch (PCTE), Polyethersulfone (PES), and Polytetrafluoroethylene (PTFE).

7. The method of claim 1, wherein the pulsing of the compressed air includes generating a flow of the compressed air in opposition to a flow of operative fluid through the pulse filter during operation of the gas turbine.

8. The method of claim 1, wherein the pulse filter is one of a plurality of pulse filters positioned within the inlet to the turbine component of the gas turbine, wherein the coupling further includes coupling each of a plurality of filter bags to a respective one of the plurality of pulse filters, and wherein the pulsing of the compressed air includes pulsing the compressed air through each of the plurality pulse filters and the plurality of coupled filter bags substantially simultaneously.

9. The method of claim 1, wherein the coupling of the filter bag to the pulse filter further includes coupling the filter bag to a support member of the pulse filter, the support member mechanically coupling the pulse filter to a pulsing line of a filter treatment assembly.

10. The method of claim 1, further comprising conditioning the pulsing of the compressed air through the pulse filter and the filter bag on a pressure drop across the pulse filter exceeding a predetermined value.

11. A turbine filtration system comprising:
a pulse filter for an inlet to a turbine component of a gas turbine; and
a hydrophilic filter bag coupled to the pulse filter and having a complementary geometry relative to the pulse filter, such that the hydrophilic filter bag occupies an airflow cross-section of the pulse filter, wherein the pulse filter and the hydrophilic filter bag are each in fluid communication with a reservoir of compressed air within the gas turbine.

12. The system of claim 11, wherein an operative fluid in the airflow cross section of the pulse filter has a temperature below zero degrees Celsius.

13. The system of claim 11, wherein the complementary geometry of the hydrophilic filter bag includes an undulating surface area.

14. The system of claim 11, wherein the hydrophilic filter bag includes an expandable fabric and a hydrophilic surface treatment on an exterior surface of the expandable fabric, the hydrophilic surface treatment including one of a membrane or a chemical treatment formed on an the exterior surface.

15. The system of claim 14, wherein the expandable fabric includes at least one material selected from a group consisting of Polycarbonate Trach Etch (PCTE), Polyethersulfone (PES) and Polytetrafluoroethylene (PTFE).

16. The system of claim 11, wherein the pulse filter includes a plurality of pulse filters positioned within the inlet to the turbine component of the gas turbine, and wherein each of the plurality of pulse filters is coupled to a respective hydrophilic filter bag.

17. The system of claim 11, further comprising a support member mechanically coupling the pulse filter to a pulsing line of a filter treatment assembly, and wherein the hydrophilic filter bag is coupled to the support member.

18. A system comprising:
a turbine component including an inlet;
a pulse filter positioned within the inlet of the turbine component;
a hydrophilic filter bag coupled to the pulse filter and having a complementary geometry relative to the pulse filter, such that the hydrophilic filter bag occupies an airflow cross-section of the pulse filter; and
a filter treatment assembly in fluid communication with the pulse filter and hydrophilic filter bag, the filter treatment assembly including:
a pulsing line fluidly coupled between the inlet and a reservoir of compressed air, and
a control valve positioned between the pulsing line and the compressed air reservoir, such that the control valve selectively permits a flow of compressed air from the reservoir to flow from the pulsing line, in opposition to a flow of operative fluid through the inlet to the turbine component, to the pulse filter and the hydrophilic filter bag.

19. The system of claim 18, wherein the hydrophilic filter bag includes an expandable fabric and a hydrophilic surface treatment on an exterior surface of the expandable fabric, the hydrophilic surface treatment including one of a membrane or a chemical treatment formed on an the exterior surface.

20. The system of claim 19, wherein the expandable fabric includes at least one material selected from a group consisting of Polycarbonate Trach Etch (PCTE), Polyethersulfone (PES), and Polytetrafluoroethylene (PTFE).
